(19) United States
(12) Patent Application Publication
(10) Pub. No.: US 2008/0089356 A1
(43) Pub. Date: Apr. 17, 2008

(54) VoIP device and service switching method thereof

(75) Inventors: Shin-Hsin Hsu, Tu-Cheng (TW); Jeng-Shyan Yang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: Hon Hai Precision Industry Co., LTD.

(21) Appl. No.: 11/647,732

(22) Filed: Dec. 29, 2006

(30) Foreign Application Priority Data
Oct. 11, 2006 (CN) 200610063034.0

(51) Int. Cl. H04L 12/66

(52) U.S. Cl. 370/463

(57) ABSTRACT

A service switching method includes: providing a time division data bus including a plurality of time slots; receiving a telephone number via a subscriber interface module; determining whether a required service is a first service; assigning a first time slot to the subscriber interface module and a first processing module if the required service is the first service; and transmitting and receiving data between the subscriber interface module and the first processing module via the time division data bus in the first time slot. A voice over Internet protocol (VoIP) device employing the method is also provided.

### BACKGROUND OF THE INVENTION

1. Field of the Invention

The invention relates to voice over Internet protocol (VoIP), and particularly to a VoIP device and a service switching method.

2. Description of Related Art

Generally, telephone communication services include a public switched telephone network (PSTN) service and a voice over Internet protocol (VoIP) service. The PSTN service is popular for standard telephone communications, and the VoIP service is to transmit voice and image packets through an open network to provide telephone communication service.

The charge for the VoIP service is significantly cheaper than that for the PSTN service, but the voice quality of the VoIP service is worse than that of the PSTN service. Thus, a VoIP gateway that can provide both the VoIP service and the PSTN service is developed. However, how to automatically and simply switch between the two services becomes a big challenge for designers of the VoIP gateway.

### SUMMARY OF THE INVENTION

An exemplary embodiment of the present invention provides a voice over Internet protocol (VoIP) device. The VoIP device includes a first time division data bus, at least one subscriber interface module, a switch control module, a telephony interface module, a first processing module, and a second processing module. The first time division data bus includes a plurality of time slots. The at least one subscriber interface module receives a telephone number from a corresponding telephone set. The switch control module determines whether a required service is a first service or a second service according to the telephone number. The telephony interface module assigns a first time slot or a second time slot to the subscriber interface module according to the determined result of the switch control module. The first processing module, connected to the subscriber interface module via the first time division data bus, uses the first time slot when the required service is the first service, to transmit data to and receive data from the subscriber interface module via the first time division data bus. The second processing module, connected to the subscriber interface module via the first time division data bus, uses the second time slot when the required service is the second service, to transmit data to and receive data from the subscriber interface module via the first time division data bus.

Another exemplary embodiment of the present invention provides a service switching method. The method includes: providing a time division data bus including a plurality of time slots; receiving a telephone number via a subscriber interface module; determining whether a required service is a first service; assigning a first time slot to the subscriber interface module and a first processing module if the required service is the first service; and transmitting and receiving data between the subscriber interface module and the first processing module via the time division data bus in the first time slot.

Other advantages and novel features will become more apparent from the following detailed description when taken in conjunction with the accompanying drawings, in which:

### BRIEF DESCRIPTION OF THE DRAWINGS

FIG. 1 is a schematic diagram of functional modules of a voice over Internet protocol (VoIP) device of an exemplary embodiment of the present invention;

FIG. 2 is a schematic diagram showing a mapped relationship between identifiers (IDs) of subscriber interface modules and time slots of a first time division data bus;

FIG. 3 is a flowchart of a service switching method of a further exemplary embodiment of the present invention; and

FIG. 4 is a detailed flowchart of the service switching method of FIG. 3.

### DETAILED DESCRIPTION OF THE INVENTION

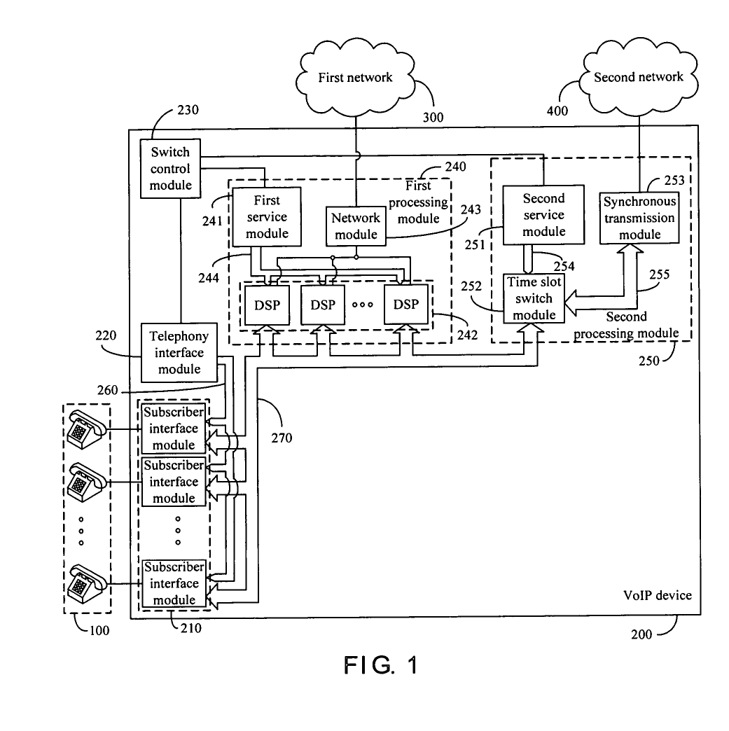

FIG. 1 is a schematic diagram of functional modules of a voice over Internet protocol (VoIP) device of an exemplary embodiment of the present invention. In the exemplary embodiment, a communication system includes a plurality of subscribers using respective telephone sets 100, a VoIP device 200, a first network 300, and a second network 400. In this embodiment, the VoIP device 200 may be a VoIP gateway, the first network 300 may be a VoIP network, and the second network 400 may be a public switched telephone network (PSTN). The plurality of telephone sets 100 are connected to the VoIP device 200, and the VoIP device 200 is connected to the first network 300 and the second network 400. The VoIP device 200 can provide a first service and a second service for the telephone sets 100. In the embodiment, the first service may be a VoIP service, and the second service may be a PSTN service.

For example, when a subscriber dials a VoIP communication number or a VoIP phone number via one of the plurality of telephone sets 100, the VoIP device 200 provides the VoIP service for the telephone set 100. When a subscriber dials a PSTN communication number or a PSTN phone number via one of the plurality of telephone sets 100, the VoIP device 200 provides the PSTN service for the telephone set 100.

In the exemplary embodiment, the VoIP device 200 includes a time division data bus including a plurality of time slots. The VoIP device 200 receives a telephone number, and determines whether a required service is a first service or a second service. Then, the VoIP device 200 switches to the required service using time division multiplexing (TDM). In detail, when the required service is the first service, a first time slot is assigned to a subscriber interface module and a first processing module. In such case, the subscriber interface module transmits data to and receives data from the first processing module via the time division data bus in the first time slot, namely providing the first service. When the required service is the second service, a second time slot is assigned to the subscriber interface module and a second processing module. In such case, the subscriber interface module transmits data to and receives data from the second processing module via the time division data bus in the second time slot, namely providing the second service.

The VoIP device 200 includes a plurality of subscriber interface modules 210, a telephony interface module 220, a switch control module 230, a first processing module 240, a second processing module 250, a first control bus 260, and a first time division data bus 270.

The first control bus 260 connects the plurality of subscriber interface modules 210 and the telephony interface module 220. In the exemplary embodiment, the first control bus 260 may be a serial bus such as a serial packet interface (SPI) bus.

The first time division data bus 270 connects the plurality of subscriber interface modules 210, the first processing module 240, and the second processing module 250. The first time division data bus 270 includes a plurality of time slots. In the exemplary embodiment, the first time division data bus 270 may be a pulse code modulation (PCM) bus.

The plurality of subscriber interface modules 210 are correspondingly connected to the plurality of telephone sets 100. Each subscriber interface module 210 is for receiving a telephone number from one corresponding telephone set 100, and informs the telephony interface module 220 of the telephone number. In the exemplary embodiment, the subscriber interface module 210 may be a subscriber line interface circuit (SLIC). When the telephone number is a VoIP phone number, the user of the telephone set 100 requires a VoIP service. When the telephone number is a PSTN phone number, the user of the telephone set 100 requires a PSTN service. In the embodiment of the present invention, the service required by the user is called a required service for short.

The telephony interface module 220, connected to the plurality of subscriber interface modules 210 via the first control bus 260, informs the switch control module 230 of the telephone number and an identifier (ID) of the subscriber interface module 210.

The switch control module 230 determines whether the required service is the first service or the second service. In the exemplary embodiment, the switch control module 230 determines whether the required service is the first service or the second service according to a local match. For example, the required service is determined according to a PSTN digit map and a VoIP digit map, according to a service type match, or according to a combination of the PSTN digit map, the VoIP digit map, and the service type match.

In other embodiments, the switch control module 230 may determine whether the required service is the first service or the second service according to a remote match. For example, the required service is determined according to an in-service database. It should be noted that the present invention does not restrict the service determination method of the VoIP and PSTN services.

When the required service is the first service, the switch control module 230 further transmits a first command to the telephony interface module 220, and a second command and the ID of the subscriber interface module 210 to the first processing module 240. The first command is for asking the telephony interface module 220 to assign one time slot to the subscriber interface module 210. The second command is for asking the first processing module 240 to assign one digital signal processor (DSP) to the subscriber interface module 210, and assign one time slot to the assigned DSP.

When receiving the first command, the telephony interface module 220 assigns a first time slot to the subscriber interface module 210 according to the first command. In the exemplary embodiment, the telephony interface module 220 stores a mapped relationship between the IDs of the subscriber interface modules 210 and the time slots of the first time division data bus 270, and assigns the first time slot to the subscriber interface module 210 according to the first command, the ID of the subscriber interface module 210, and the mapped relationship.

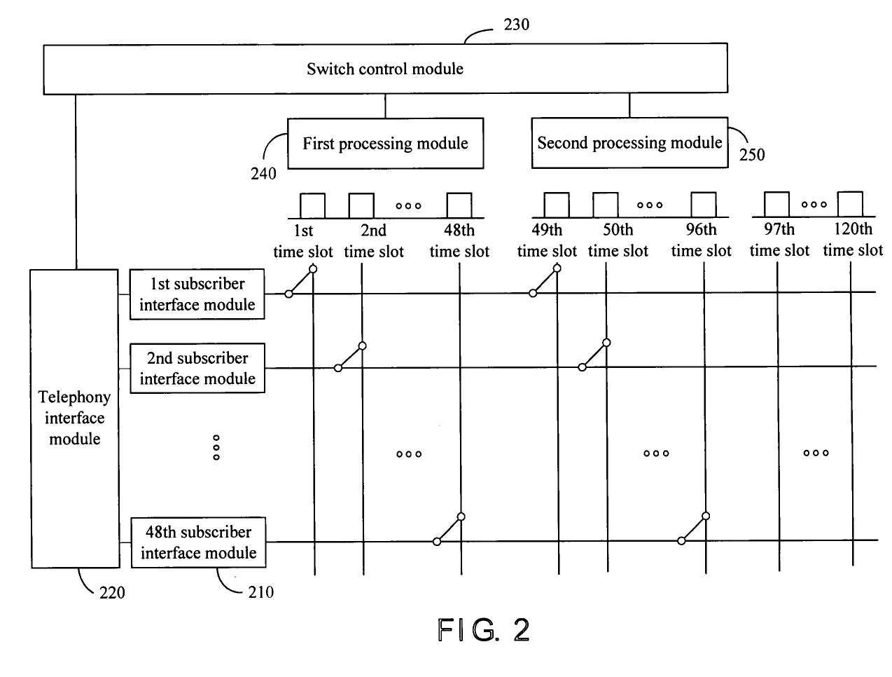

FIG. 2 is a schematic diagram showing a mapped relationship between the IDs of the subscriber interface modules 210 and the time slots of the first time division data bus 270. In the exemplary embodiment, the number of the time slots of the first time division data bus 270 is not less than double the number of the subscriber interface modules 210. In order to describe more clearly, it is assumed that the number of the subscriber interface modules 210 is 48, from a 1st subscriber interface module 210 to a 48th subscriber interface module 210. The number of the time slots of the first time division data bus 270 is not less than 96. For example, the number of the time slots is 120. In this example, the time slots of the first time division data bus 270 includes a first portion from a 1st time slot to a 48th time slot, a second portion from a 49th time slot to a 96th time slot, and a idle portion from a 97th time slot to a 120th time slot. The first time slot assigned to the subscriber interface module 210 by the telephony interface module 220 is one time slot from the first portion of the first time division data bus 270.

In the exemplary embodiment, the 1st time slot is assigned to the first service of the 1st subscriber interface module 210, and the 49th time slot is assigned to the second service of the 1st subscriber interface module 210. The 2nd time slot is assigned to the first service of the 2nd subscriber interface module 210, and the 50th time slot is assigned to the second service of the 2nd subscriber interface module 210. As such, the 48th time slot is assigned to the first service of the 48th subscriber interface module 210, and the 96th time slot is assigned to the second service of the 48th subscriber interface module 210. The time slots from 97th to 120th are idle.

Thus, when the switch control module 230 determines that a service required by the telephone set 100 connected to the 1st subscriber interface module 210 is the first service, the telephony interface module 220 assigns the 1st time slot to the 1st subscriber interface module 210, and the first processing module 240 uses the 1st time slot. Then the 1st subscriber interface module 210 transmits data to and receives data from the first processing module 240 in the 1st time slot, namely providing the first service.

When the switch control module 230 determines that a service required by the telephone set 100 connected to the 1st subscriber interface module 210 is the second service, the telephony interface module 220 assigns the 49th time slot to the 1st subscriber interface module 210, and the second processing module 250 uses the 49th time slot. Then the 1st subscriber interface module 210 transmits data to and receives data from the second processing module 250 in the 2nd time slot, namely providing the second service.

It should be noted that the mapped relationship between the IDs of the subscriber interface modules 210 and the time slots of the first time slot data bus 270 is not restricted to the mapped relationship described in FIG. 2.

In other embodiments, the telephony interface module 220 may not store the mapped relationship between the IDs of the subscriber interface modules 210 and the time slots of the first time slot data bus 270, and dynamically assigns the first time slot to the subscriber interface module 210 according to the first command.

As seen in FIG. 1 again, the first processing module 240, connected to the plurality of subscriber interface modules 210 via the first time division data bus 270, uses the first time slot when the required service is the first service, to transmit data to and receive data from the subscriber interface module 210 via the first time division data bus 270, namely providing the first service for the telephone set 100.

In the exemplary embodiment, the first processing module 240 includes a first service module 241, a plurality of DSPs 242, a network module 243, and a second control bus 244.

The second control bus 244 connects the first service module 241 and the plurality of DSPs 242. In this embodiment, the second control bus 244 is a parallel bus, such as a host port interface (HPI) bus.

The plurality of DSPs 241 are connected to the plurality of subscriber interface modules 210 via the first time division data bus 270. In the exemplary embodiment, the number of the DSPs 242 is equal to the number of the subscriber interface modules 210.

The first service module 241 assigns one DSP 242 to the subscriber interface module 210, and assigns the first time slot to the assigned DSP 242, both according to the second command. In the exemplary embodiment, the first service module 241 stores the mapped relationship between the IDs of the subscriber interface modules 210 and the time slots of the first time division data bus 270. The first service module 241 receives the second command and the ID of the subscriber interface module 210, and then assigns the first time slot according to the second command, the ID of the subscriber interface module 210, and the mapped relationship. In this embodiment of the present invention, the mapped relationship stored in the first service module 241 is the same as that stored in the telephony interface module 220, and both of the telephony interface module 220 and the first service module 241 assign the first time slot according to the ID of the subscriber interface module 210 and the same mapped relationship.

In other embodiments, the first service module 241 may not store the mapped relationship between the IDs of the subscriber interface modules 210 and the time slots of the first time division data bus 270, and dynamically assigns the first time slot to the assigned DSP 242 according to the second command.

Thus, the subscriber interface module 210 transmits data to and receives data from the assigned DSP 242 via the first time division data bus 270 in the first time slot.

When the telephone set 100 transmits data to the first network 300 via the VoIP device 200, the subscriber interface module 210 receives an analog signal from the corresponding telephone set 100, and converts the analog signal to a digital signal. The assigned DSP 242 receives the digital signal via the first time division data bus 270 in the first time slot, and converts the digital signal to real-time transport protocol (RTP) data. The network module 240 converts the RTP data to a RTP packet, and transmits the RTP packet to the first network 300.

When the telephone set 100 receives data from the first network 300 via the VoIP device 200, the network module 240 receives a RTP packet from the first network 300, and converts the RTP packet to RTP data. The assigned DSP 242 converts the RTP data to a digital signal. The subscriber interface module 210 receives the digital signal via the first time division data bus 270 in the first time slot, and converts the digital signal to an analog signal, and also transmits the analog signal to the corresponding telephone set 100.

When determining that the required service is the second service, the switch control module 230 further transmits a third command to the telephony interface module 220, and a fourth command and the ID of the subscriber interface module 210 to the second processing module 250. The third command is for asking the telephony interface module 220 to assign one time slot to the subscriber interface module 210. The fourth command is for asking the second processing module 250 to use one time slot.

When receiving the third command, the telephony interface module 220 assigns a second time slot to the subscriber interface module 210 according to the third command. In the exemplary embodiment, the telephony interface module 220 stores the mapped relationship between the IDs of the subscriber interface modules 210 and the time slots of the first time division data bus 270, and assigns the second time slot to the subscriber interface module 210 according to the third command, the ID of the subscriber interface module 210, and the mapped relationship. In the above example of FIG. 2, the second time slot is one time slot from the second portion of the first time division data bus 270, namely one time slot from the 49th to 96th time slots.

In other embodiments, the telephony interface module 220 may not store the mapped relationship between the IDs of the subscriber interface modules 210 and the time slots of the first time slot data bus 270, and dynamically assigns the second time slot to the subscriber interface module 210 according to the third command.

The second processing module 250, connected to the plurality of subscriber interface modules 210 via the first time division data bus 270, uses the second time slot when the required service is the second service, to transmit data to and receive data from the subscriber interface module 210 via the first time division data bus 270, namely providing the second service for the telephone set 100.

In the exemplary embodiment, the second processing module 250 includes a second service module 251, a time slot switch module 252, a synchronous transmission module 253, a third control bus 254, and a second time division data bus 255.

The third control bus 254 connects the second service module 251 and the time slot switch module 252. In this embodiment, the third control bus 254 is a parallel bus, such as an HPI bus.

The time slot switch module 252 is connected to the plurality of subscriber interface modules 210 via the first time division data bus 270.

The second service module 251 assigns the second time slot to the time slot switch module 252 according to the fourth command. In the exemplary embodiment, the second service module 251 stores the mapped relationship between the IDs of the subscriber interface modules 210 and the time slots of the first time division data bus 270. The second service module 251 receives the fourth command and the ID of the subscriber interface module 210, and then assigns the second time slot according to the fourth command, the ID of the subscriber interface module 210, and the mapped relationship. In this embodiment of the present invention, the mapped relationship stored in the second service module 251 is the same as that stored in the telephony interface module 220, and both of the telephony interface module 220 and the second service module 251 assign the second time slot according to the ID of the subscriber interface module 210 and the same mapped relationship.

In other embodiments, the second service module 251 may not store the mapped relationship between the IDs of the subscriber interface modules 210 and the time slots of the first time division data bus 270, and dynamically assigns the second time slot to the time slot switch module 252 according to the fourth command.

Thus, the subscriber interface module 210 transmits data to and receives data from the time slot switch module 252 via the first time division data bus 270 in the second time slot.

When the telephone set 100 transmits data to the second network 400 via the VoIP device 200, the subscriber module 210 receives an analog signal from the corresponding telephone set 100, and converts the analog signal to a digital signal. The time slot switch module 252 receives the digital signal via the first time division data bus 270 in the second time slot, and switches the digital signal from the second time slot to a third time slot. The synchronous transmission module 253 receives the digital signal via the second time division data bus 255 in the third time slot, and converts the digital signal to an E1/T1 signal, and also transmits the E1/T1 signal to the second network 400.

When the telephone set 100 receives data from the second network 400 via the VoIP device 200, the synchronous transmission module 253 receives an E1/T1 signal from the second network 400, and converts the E1/T1 signal to a digital signal. The time slot switch module 252 receives the digital signal via the second time division data bus 255 in a third time slot, and switches the digital signal from the third time slot to a second time slot. The subscriber interface module 210 receives the digital signal via the first time division data bus 270 in the second time slot, and converts the digital signal to an analog signal, and also transmits the analog signal to the corresponding telephone set 100.

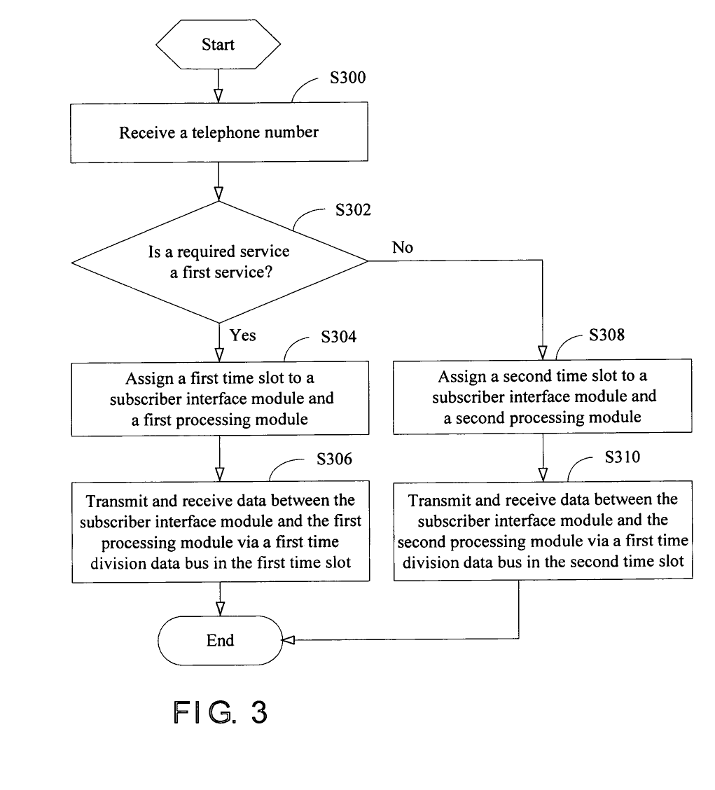

FIG. 3 is a flowchart of a service switching method of an exemplary embodiment of the present invention.

In step S300, one of the plurality of subscriber interface modules 210 receives a telephone number. In the exemplary embodiment, the subscriber interface module 210 receives the telephone number from one corresponding telephone set 100, and then transmits the telephone number to the switch control module 230 via the telephony interface module 220.

In step S302, the switch control module 230 determines whether a required service is a first service.

If the required service is the first service, in step S304, a first time slot is assigned to the subscriber interface module 210 and the first processing module 240. That is, the telephony interface module 220 assigns the first time slot to the subscriber interface module 210, and the first processing module 240 uses the first time slot.

In step S306, the subscriber interface module 210 transmits data to and receives data from the first processing module 240 via the first time division data bus 270 in the first time slot, namely providing the first service for the telephone set 100.

If the required service is not the first service, in step S308, a second time slot is assigned to the subscriber interface module 210 and the second processing module 250. That is, the telephony interface module 220 assigns the second time slot to the subscriber interface module 210, and the first processing module 240 uses the second time slot.

In step S310, the subscriber interface module 210 transmits data to and receives data from the second processing module 250 via the first time division data bus 270 in the second time slot, namely providing the second service for the telephone set 100.

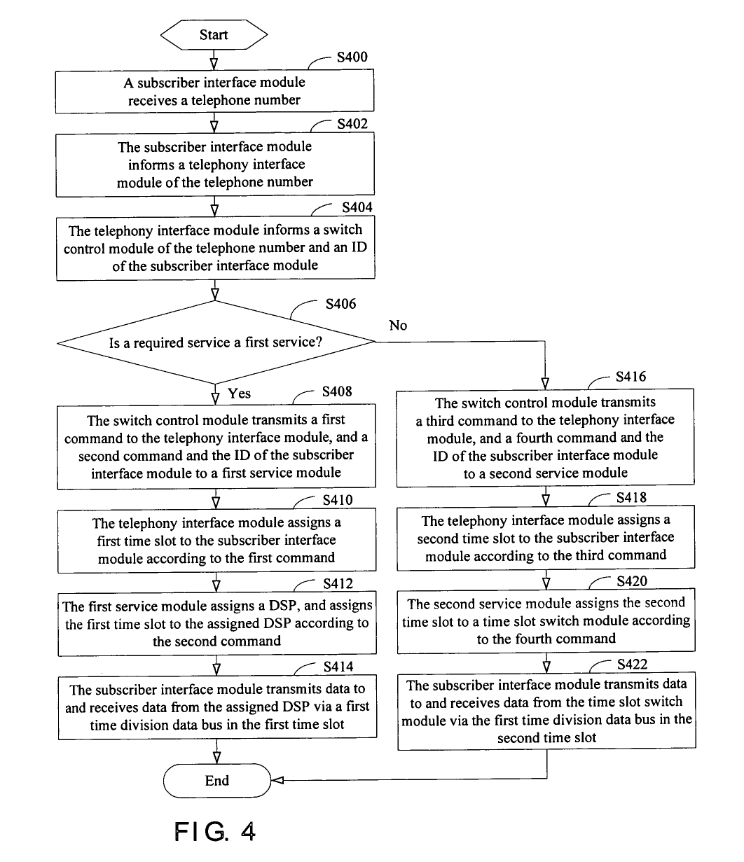

FIG. 4 is a detailed flowchart of the service switching method of FIG. 3.

In step S400, one of the plurality of subscriber interface modules 210 receives a telephone number from one corresponding telephone set 100.

In step S402, the subscriber interface module 210 informs the telephony interface module 220 of the telephone number.

In step S404, the telephony interface module 220 informs the switch control module 230 of the telephone number and an ID of the subscriber interface module 210.

In step S406, the switch control module 230 determines whether a required service is a first service. In the exemplary embodiment, the switch control module 230 determines whether the required service is the first service according to a local match.

In other embodiments, the switch control module 230 may determine whether the required service is the first service according to a remote match. It should be noted that the present invention does not restrict the service determination method of the VoIP and PSTN services.

If the required service is the first service, in step S408, the switch control module 230 transmits a first command to the telephony interface module 220, and a second command and the ID of the subscriber interface module 210 to the first service module 241. The first command is for asking the telephony interface module 220 to assign one time slot to the subscriber interface module 210. The second command is for asking the first service module 241 to assign one DSP to the subscriber interface module 210, and assign one time slot to the assigned DSP.

In step S410, the telephony interface module 220 assigns a first time slot to the subscriber interface module 210 according to the first command. In the exemplary embodiment, the telephony interface module 220 stores the mapped relationship between the IDs of the subscriber interface modules 210 and the time slots of the first time division data bus 270, and assigns the first time slot to the subscriber interface module 210 according to the first command, the ID of the subscriber interface module 210, and the mapped relationship.

In other embodiments, the telephony interface module 220 may not store the mapped relationship between the IDs of the subscriber interface modules 210 and the time slots of the first time slot data bus 270, and dynamically assigns the first time slot to the subscriber interface module 210 according to the first command.

In step S412, the first service module 241 assigns one DSP 242 to the subscriber interface module 210, and assigns the first time slot to the assigned DSP 242, both according to the second command. In the exemplary embodiment, the first service module 241 stores the mapped relationship between the IDs of the subscriber interface modules 210 and the time slots of the first time division data bus 270. The first service module 241 receives the second command and the ID of the subscriber interface module 210, and then assigns the first time slot according to the second command, the ID of the subscriber interface module 210, and the mapped relationship.

In other embodiments, the first service module 241 may not store the mapped relationship between the IDs of the subscriber interface modules 210 and the time slots of the first time division data bus 270, and dynamically assigns the first time slot to the assigned DSP 242 according to the second command.

In this embodiment, the sequences of steps S410 and S412 are not restricted. Steps S410 and S412 may be executed simultaneously or one after the other.

In step S414, the subscriber interface module 210 transmits data to and receives data from the assigned DSP 242 via the first time division data bus 270 in the first time slot.

If the switch control module 230 determines that the required is not the first service, in step S416, the switch control module 230 transmits a third command to the telephony interface module 220, and a fourth command and the ID of the subscriber interface module 210 to the second service module 251. The third command is for asking the telephony interface module 220 to assign one time slot to the subscriber interface module 210. The fourth command is for asking the second service module 251 to assign one time slot to the time slot switch module 252.

In step S418, the telephony interface module 220 assigns a second time slot to the subscriber interface module 210 according to the third command. In the exemplary embodiment, the telephony interface module 220 stores the mapped relationship between the IDs of the subscriber interface modules 210 and the time slots of the first time division data bus 270, and assigns the second time slot to the subscriber interface module 210 according to the third command, the ID of the subscriber interface module 210, and the mapped relationship.

In other embodiments, the telephony interface module 220 may not store the mapped relationship between the IDs of the subscriber interface modules 210 and the time slots of the first time slot data bus 270, and dynamically assigns the second time slot to the subscriber interface module 210 according to the third command.

In step S420, the second service module 251 assigns the second time slot to the time slot switch module 252 according to the fourth command. In the exemplary embodiment, the second service module 251 stores the mapped relationship between the IDs of the subscriber interface modules 210 and the time slots of the first time division data bus 270. The second service module 251 receives the fourth command and the ID of the subscriber interface module 210, and then assigns the second time slot according to the fourth command, the ID of the subscriber interface module 210, and the mapped relationship.

In other embodiments, the second service module 251 may not store the mapped relationship between the IDs of the subscriber interface module 210 and the time slots of the first time division data bus 270, and dynamically assigns the second time slot to the time slot switch control module 252 according to the fourth command.

In this embodiment, the sequences of steps S418 and S420 are not restricted. Steps S418 and S420 may be executed simultaneously or one after the other.

In step S422, the subscriber interface module 210 transmits data to and receives data from the time slot switch module 252 via the first time division data bus 270 in the second time slot.

Thus, the VoIP device 200 automatically and simply switches between the first service and the second service by use of TDM.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A voice over Internet protocol (VoIP) device comprising:
a first time division data bus, comprising a plurality of time slots;
at least one subscriber interface module, for receiving a telephone number from a corresponding telephone set;
a switch control module, for determining whether a required service is a first service or a second service according to the telephone number;
a telephony interface module, for assigning a first time slot or a second time slot to the subscriber interface module according to the determined result of the switch control module;
a first processing module, connected to the subscriber interface module via the first time division data bus, for using the first time slot when the required service is the first service, to transmit data to and receive data from the subscriber interface module via the first time division data bus; and
a second processing module, connected to the subscriber interface module via the first time division data bus, for using the second time slot when the required service is the second service, to transmit data to and receive data from the subscriber interface module via the first time division data bus.

2. The VoIP device as claimed in clam 1, wherein the subscriber interface module is a subscriber line interface circuit (SLIC), and the first time division data bus is a pulse code modulation (PCM) bus.

3. The VoIP device as claimed in claim 1, further comprising a first control bus, for connecting the telephony interface module and the subscriber interface module; the first control bus is a serial bus.

4. The VoIP device as claimed in claim 1, wherein the switch control module transmits a first command to the telephony interface module and a second command to the first processing module when the required service is the first service; the telephony interface module assigns the first time slot to the subscriber interface module according to the first command.

5. The VoIP device as claimed in claim 4, wherein the first processing module comprises:
at least one digital signal processor (DSP), connected to the at least one subscriber interface module via the first time division data bus; and
a first service module, for assigning one DSP to the subscriber interface module, and assigning the first time slot to the assigned DSP, both according to the second command;
wherein the subscriber interface module transmits data to and receives data from the assigned DSP via the first time division data bus in the first time slot.

6. The VoIP device as claimed in claim 5, wherein the telephony interface module transmits an identifier (ID) of the subscriber interface module to the switch control module; the switch control module further transmits the ID of the subscriber interface module to the first service module when the required service is the first service; the first service module stores a mapped relationship between the ID of the at least one subscriber interface module and the time slots; the first service module assigns the first time slot to the assigned DSP according to the second command, the ID of the subscriber interface module, and the mapped relationship.

7. The VoIP device as claimed in claim 5, wherein the first processing module further comprises a second control bus, for connecting the first service module and the at least one DSP; the second control bus is a parallel bus.

8. The VoIP device as claimed in claim 5, wherein the first processing module further comprises a network module, for converting a real-time transport (RTP) packet received from a first network to RTP data, and converting RTP data received from the DSP to an RTP packet; the subscriber interface module is for converting an analog signal received from the corresponding telephone set to a digital signal, and converting a digital signal received from the DSP to an analog signal; the DSP is for converting a digital signal received from the subscriber interface module to RTP data, and converting RTP data received from the network module to a digital signal.

9. The VoIP device as claimed in claim 1, wherein the switch control module further transmits a third command to the telephony interface module when the required service is the second service, and transmits a fourth command to the second processing module; the telephony interface module assigns the second time slot to the subscriber interface module according to the third command.

10. The VoIP device as claimed in claim 9, wherein the second processing module comprises:
a time slot switch module, connected to the at least one subscriber interface module via the first time division data bus; and
a second service module, for assigning the second time slot to the time slot switch module according to the fourth command;
wherein the subscriber interface module transmits data to and receives data from the time slot switch module via the first time division data bus in the second time slot.

11. The VoIP device as claimed in claim 10, wherein the telephony interface module further transmits an ID of the subscriber interface module to the switch control module; the switch control module transmits the ID of the subscriber interface module to the second service module when the required service is the second service; the second service module stores a mapped relationship between the ID of the at least one subscriber interface module and the time slots; the second service module assigns the second time slot to the time slot switch module according to the fourth command, the ID of the subscriber interface module, and the mapped relationship.

12. The VoIP device as claimed in claim 10, wherein the second processing module further comprises a third control bus, for connecting the second service module and the time slot switch module; the third control bus is a parallel bus.

13. The VoIP device as claimed in claim 10, wherein the second processing module further comprises a synchronous transmission module, connected to the time slot switch module via a second time division data bus, for converting an E1/T1 signal received from a second network to a digital signal, and converting a digital signal received from the time slot switch module to an E1/T1 signal; the subscriber interface module is for converting an analog signal received from the corresponding telephone set to a digital signal, and converting a digital signal received from the time slot switch module to an analog signal; the time slot switch module is for switching a digital signal from the synchronous transmission module from a third time slot to the second time slot, and switching a digital signal received from the subscriber interface module from the second time slot to a third time slot.

14. A service switching method, comprising:
providing a time division data bus comprising a plurality of time slots;
receiving a telephone number via a subscriber interface module;
determining whether a required service is a first service;
assigning a first time slot to the subscriber interface module and a first processing module if the required service is the first service; and
transmitting and receiving data between the subscriber interface module and the first processing module via the time division data bus in the first time slot.

15. The service switching method as claimed in claim 14, wherein assigning the first time slot to the subscriber interface module and the first processing module comprises:
transmitting a first command and a second command;
assigning the first time slot to the subscriber interface module according to the first command; and
assigning a digital signal processor (DSP) to the subscriber interface module, and assigning the first time slot to the assigned DSP, both according to the second command.

16. The service switching method as claimed in claim 15, further comprising:
transmitting the telephone number and an identifier (ID) of the subscriber interface module from a telephony interface module to a switch control module;
transmitting the ID of the subscriber interface module from the switch control module to the first processing module;
assigning the first time slot to the assigned DSP according to the second command, the ID of the subscriber interface module, and a mapped relationship between the ID of the subscriber interface module and the plurality of time slots; and
transmitting and receiving data between the subscriber interface module and the assigned DSP via the time division data bus in the first time slot.

17. The service switching method as claimed in claim 14, further comprising:
assigning a second time slot to the subscriber interface module and a second processing module if the required service is not the first service; and
transmitting and receiving data between the subscriber interface module and the second processing module via the time division data bus in the second time slot.

18. The service switching method as claimed in claim 17, wherein assigning the second time slot to the subscriber interface module and the second processing module comprises:
transmitting a third command and a fourth command;
assigning the second time slot to the subscriber interface module according to the third command; and
assigning the second time slot to the second processing module according to the fourth command.

19. The service switching method as claimed in claim 18, further comprising:
transmitting the telephone number and an identifier (ID) of the subscriber interface module from a telephony interface module to a switch control module;
transmitting the ID of the subscriber interface module from the switch control module to the second processing module; and
assigning the second time slot to the second processing module according to the fourth command, the ID of the subscriber interface module, and a mapped relationship between the ID of the subscriber interface module and the plurality of time slots.

20. A method for switching different communication services provided by at least two service networks respectively, comprising steps of:
providing a data bus comprising a plurality of time slots each of which is able to communicate a subscriber interface module with at least two service networks respectively providing different communication services;
receiving a communication number from a subscriber through said subscriber interface module;
determining one of said different communication services to be required by said subscriber according to said received communication number;
assigning one of said plurality of time slots of said data bus to said subscriber interface module and a processing module correspondingly to provide said one of said different communication services through a corresponding one of said at least two service networks; and
communicating said subscriber interface module with said processing module via said one of said plurality of time slots of said data bus.
